(19) United States
(12) Patent Application Publication
(10) Pub. No.: US 2017/0186348 A1
(43) Pub. Date: Jun. 29, 2017

(54) DETECTING METHOD AND DETECTING APPARATUS FOR SCAN DRIVING CIRCUIT AND LIQUID CRYSTAL PANEL

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventor: Sikun HAO, Shenzhen, Guangdong (CN)

(73) Assignees: Shenzhen China Star Optoelectronics Technology Co., Ltd., Shenzhen, Guangdong (CN); Wuhan China Star Optoelectronics Technology Co., Ltd., Wuhan, Hubei (CN)

(21) Appl. No.: 14/889,549

(22) PCT Filed: Oct. 21, 2015
(86) PCT No.: PCT/CN2015/092355

§ 371 Date: Nov. 6, 2015

(30) Foreign Application Priority Data
Jun. 29, 2015 (CN) 201510371840.3

(51) Int. Cl. G09G 3/00; G09G 3/36

(52) U.S. Cl. CPC G09G 3/006; G09G 3/3677; G09G 2310/08; G09G 2310/0218; G09G 2330/12; G09G 2300/0408

(57) ABSTRACT

The invention provides a detecting method for a scan driving circuit. The scan driving circuit includes multiple scan driving units connected in cascade. The detecting method includes steps of: controlling the plurality of scan driving units sequentially to provide scan signals respectively to a plurality of scan lines; detecting a pulse signal sequence(s) induced on at least one data line crossing over and capacitively coupling with the plurality of scan lines; and determining a position of an abnormal scan driving unit in the scan driving circuit according to the pulse signal sequence(s). By way of the above solution, the invention can effectively detect the position of the abnormal scan driving unit in the scan driving circuit.

### TECHNICAL FIELD

The invention relates to the field of liquid crystal panel detection technology, and particularly to a detecting method and a detecting apparatus for a scan driving circuit and a liquid crystal panel.

### DESCRIPTION OF RELATED ART

The liquid crystal display device currently is the most widely used flat panel display device and has become display devices with high resolution color screen widely used for various electronic apparatuses such as mobile phones, personal digital assistants (PDAs), digital cameras, computer screens or laptop screens. With the development and progress of the liquid crystal display technology, people have put forward higher requirements for display quality, appearance design and so on of liquid crystal display devices, low cost and narrow border have become goals pursued by people.

A GOA circuit is a scan driving circuit and used for providing scan signals for scan lines. The GOA (i.e., gate driver on array) has advantages of reducing production cost and narrowing border and thus is employed by a variety of display devices. According to types of active devices used by display devices, GOA circuits can be classified into amorphous silicon (a-Si) GOA, indium gallium zinc oxide (IGZO) GOA, low temperature polysilicon (LTPS) GOA and so on. Each type of GOA circuit may use a different manufacturing process. A LTPS manufacturing process has advantages of high electron mobility and mature technology and thus is widely used by small and medium sized display devices.

The liquid crystal display device includes multiple (i.e., more than one) circuit modules such as ESD protection circuit, circuit multiplexer, shift registers (GOA type) and so on, such modules have the largest proportion in the GOA circuit, layout thereof are the most complex, and are most prone to bad products in actual production, and therefore it is necessary to propose an effective GOA circuit detecting method.

### SUMMARY

A technical problem mainly to be solved by the invention is to provide a detecting method and a detecting apparatus for a scan driving circuit and a liquid crystal panel, which can effectively detect a position of an abnormal scan driving unit in the scan driving circuit.

In order to solve the above technical problem, a technical solution proposed by the invention is to provide a detecting method for a scan driving circuit. The scan driving circuit includes cascade-connected a plurality of scan driving unit. The detecting method includes: controlling the plurality of scan driving units sequentially to provide scan signals respectively to a plurality of scan lines; detecting a pulse signal sequence(s) induced on at least one data line crossing over and capacitively coupling with the plurality of scan lines; and determining a position of an abnormal scan driving unit in the scan driving circuit according to the pulse signal sequence(s).

In one embodiment, the step of determining a position of an abnormal scan driving unit in the scan driving circuit according to the pulse signal sequence(s) includes: determining a quantity of pulse signal of each the pulse signal sequence; and determining the position of the abnormal scan driving unit in the scan driving circuit according to the quantity of pulse signal.

In one embodiment, the step of controlling the plurality of scan driving units sequentially to provide scan signals respectively to a plurality of scan lines includes: controlling N numbers of scan driving units sequentially to provide scan signals respectively to N numbers of scan lines as per an order from a first scan line to an Nth scan line, where N≧3; and the step of determining the position of the abnormal scan driving unit in the scan driving circuit according to the quantity of pulse signal includes: comparing the quantity of pulse signal n with the quantity of scan line N, and if the quantity of pulse signal n is less than the quantity of scan line N, determining the scan driving unit corresponding to an (n+1)th scan line as abnormal.

In an alternative embodiment, the step of controlling the plurality of scan driving units sequentially to provide scan signals respectively to a plurality of scan lines includes: using N numbers of clock signals sequentially to control N numbers of scan driving units to provide scan signals respectively to N numbers of scan lines as per an order from a first scan line to an Nth scan line, where N≧3; and the step of determining the position of the abnormal scan driving unit in the scan driving circuit according to the quantity of pulse signal includes: comparing the quantity of pulse signal n with the quantity of clock signal N, and if the quantity of pulse signal n is less than the quantity of clock signal N, determining the scan driving unit corresponding to an (n+1)th scan line as abnormal.

In one embodiment, the step of detecting a pulse signal sequence(s) induced on at least one data line crossing over and capacitively coupling with the plurality of scan lines includes: obtaining the pulse signal sequence outputted by a detecting terminal electrically connected to one data line crossing over the plurality of scan lines.

In an alternative embodiment, the step of detecting a pulse signal sequence(s) induced on at least one data line crossing over and capacitively coupling with the plurality of scan lines includes: obtaining a plurality of the pulse signal sequences outputted by a plurality of detecting terminals electrically connected to a plurality of data lines crossing over the plurality of scan lines; and the step of determining a position of an abnormal scan driving unit in the scan driving circuit according to the pulse signal sequence(s) includes: summarizing the plurality of pulse signal sequences to determine the position of the abnormal scan driving unit in the scan driving circuit.

In order to solve the above technical problem, another technical solution provided by the invention is to provide a liquid crystal panel. The liquid crystal panel includes a scan driving circuit, a plurality of data lines and a plurality of scan lines. The scan driving circuit includes a plurality of scan driving units connected in cascade, the plurality of scan driving units are configured for sequentially providing scan signals respectively to the plurality of scan lines, the plurality of data lines are crossing over and capacitively coupling with the plurality of scan lines. The liquid crystal panel further is disposed with a detecting terminal(s) electrically connected to at least one of the plurality of data lines, the detecting terminal(s) is/are configured for outputting a pulse signal sequence(s) induced on the at least one data line by the scan signals.

In order to solve the above technical problem, still another embodiment provided by the invention is to provide a detecting apparatus for a scan driving circuit. The scan driving circuit includes a plurality of scan driving units connected in cascade, the detecting apparatus includes a central processing module and a waveform detecting module. The central processing module is configured for controlling the plurality of scan driving units sequentially to provide scan signals respectively to a plurality of scan lines, the waveform detecting module is configured for detecting a pulse signal sequence(s) induced on at least one data line crossing over and capacitively coupling with the plurality of scan lines, and the central processing module further is configured for determining a position of an abnormal scan driving unit in the scan driving circuit according to the pulse signal sequence(s).

In one embodiment, the central processing module is configured for determining a quantity of pulse signal of each the pulse signal sequence and determining the position of the abnormal scan driving unit in the scan driving circuit according to the quantity of pulse signal.

In one embodiment, the waveform detecting module is configured for obtaining the pulse signal sequence outputted by a detecting terminal electrically connected to one data line crossing over the plurality of scan lines; or the waveform detecting module is configured for obtaining a plurality of the pulse signal sequences outputted by a plurality of detecting terminals electrically connected to the plurality of data lines crossing over the plurality of scan lines, and the central processing module further is configured for summarizing the plurality of pulse signal sequences to determine the position of the abnormal scan driving unit in the scan driving circuit.

In one embodiment, the central processing module is configured for controlling N numbers of scan driving units sequentially to provide scan signals respectively to N numbers of scan lines as per an order from a first scan line to an Nth scan line, where N≧3; the central processing module further is configured for comparing the quantity of pulse signal n with the quantity of scan line N, and if the quantity of pulse signal n is less than the quantity of scan line N, determining the scan driving unit corresponding to an (n+1) scan line as abnormal.

In an alternative embodiment, the central processing module is configured for using N numbers of clock signals sequentially to control N numbers of scan driving units to provide scan signal respectively to N numbers of scan lines as per an order from a first scan line to an Nth scan line, where N≧3; the central processing module further is configured for comparing the quantity of pulse signal n with the quantity of clock signal N, and if the quantity of pulse signal n is less than the quantity of clock signal N, determining the scan driving unit corresponding to an (n+1) scan line as abnormal.

Efficacy can be achieved by the invention is that: different from the prior art, the invention detects a pulse signal sequence(s) induced on at least one data line crossing over and capacitively coupling with a plurality of scan lines and determines a position of an abnormal scan driving unit in a scan driving circuit according to the detected pulse signal sequence, and therefore can effectively detect the position of the abnormal scan driving unit in the scan driving circuit.

### BRIEF DESCRIPTION OF THE DRAWINGS

FIG. 1 is a schematic structural view of a liquid crystal panel according to an embodiment of the invention;

FIG. 2 is a flowchart of a detecting method for a scan driving circuit according to an embodiment of the invention;

FIG. 2a is a schematic structural view of a liquid crystal panel disposed with only one detecting terminal according to another embodiment of the invention;

FIG. 3 is a timing diagram of a pulse signal sequence, a clock signal sequence and scan signals on multiple scan lines according to an embodiment of the invention;

FIG. 4 is a schematic diagram of another waveform of a pulse signal sequence according to an embodiment of the invention;

FIG. 5 is a schematic structural view of another liquid crystal panel according to an embodiment of the invention; and

FIG. 6 is a schematic block diagram of a detecting apparatus for a scan driving circuit according to an embodiment of the invention.

### DETAILED DESCRIPTION OF EMBODIMENTS

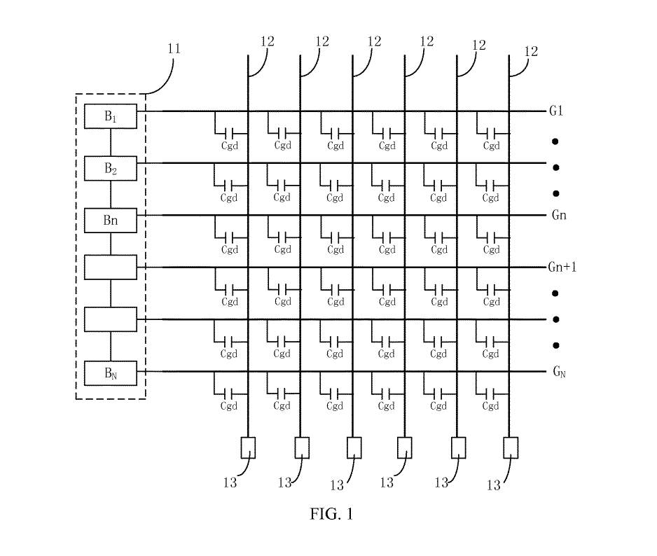

Referring to FIG. 1, FIG. 1 is a schematic structural view of a liquid crystal panel according to an embodiment of the invention. In the illustrated embodiment, the liquid crystal panel includes a scan driving circuit 11, a plurality of data lines 12 and a plurality scan lines G₁˜G_{N} .

The scan driving circuit 11 includes a plurality of scan driving units B₁˜B_{N} connected in cascade. The plurality of scan driving units B₁˜B_{N} are configured (i.e., structured and arranged) for sequentially providing scan signals respectively to the plurality of scan lines G₁˜G_{N}.

For example, the plurality of scan driving units B₁˜B_{N} sequentially provide scan signals respectively to the plurality of scan lines G₁˜G_{N} as per an order from the first scan line G₁ to the Nth scan line G_{N}, so that the scan driving unit B₁ provides a corresponding one of the scan signals to the scan line G₁, the next stage scan driving unit B₂ then provides a corresponding one of the scan signals to the scan line G₂, the further next stage scan driving unit B₃ subsequently provides a corresponding one of the scan signals to the scan line G₃, and so forth, until the scan driving unit B_{N} provides a corresponding one of the scan signals to the scan line G_{N} . Moreover, when a certain stage scan driving unit B_{K} (k is greater than or equal to 1 and less than or equal to N) is abnormal, the certain stage and all the succeeding stage(s) scan driving units B_{K}˜B_{N} will no longer provide corresponding scan signals respectively to the scan lines G_{K}˜G_{N}.

The plurality of data lines 12 are arranged crossing over and capacitively coupling with the plurality of scan lines G₁˜G_{N}. As illustrated in FIG. 1, each of the data lines 12 is perpendicularly crossing over all the scan lines G₁˜G_{N}, and the data line 12 and each of the scan lines G₁˜G_{N} form a coupling capacitor C_{gd} therebetween, so that the scan signals on the plurality of scan lines G₁˜G_{N} would induce a pulse signal sequence on each of the data lines 12 by the coupling capacitors C_{gd}.

The liquid crystal panel further is disposed with a detecting terminal(s) 13 electrically connected to at least one data line 12, and each the detecting terminal 13 is configured for outputting a pulse signal sequence induced on the data line 12 by the scan signals.

For example, the liquid crystal panel may include a plurality of detecting terminals 13 respectively electrically connected to ends of the plurality of data lines 12, each of the determining terminals 13 is configured for outputting a pulse signal sequence induced on a corresponding data line 12 by the scan signals.

For example, alternatively, the liquid crystal panel may be disposed with only one detecting terminal 13 electrically connected to an end of one data line 12, and the detecting terminal 13 is configured for outputting a pulse signal sequence induced on the data line 12 by the scan signals.

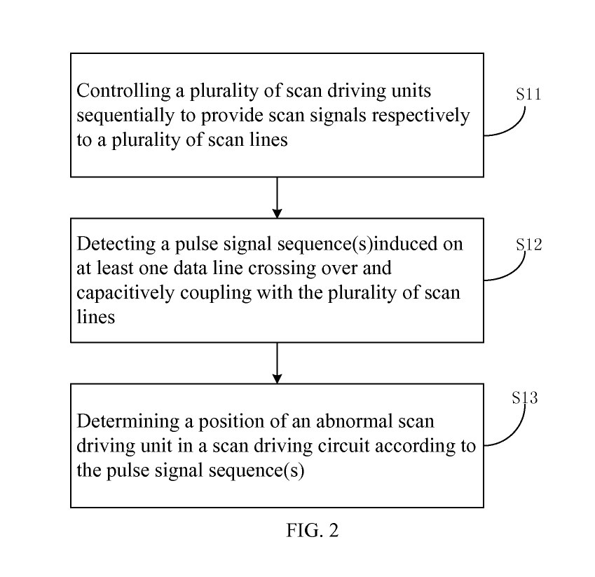

Referring to FIG. 2 in conjunction with FIG. 1, FIG. 2 is a flowchart of a detecting method for a scan driving circuit according to an embodiment of the invention. In the illustrated embodiment, the scan driving circuit 11 includes a plurality of scan driving units B₁˜B_{N} connected in cascade, and a detecting method for the scan driving circuit includes following steps:

Step S11: controlling a plurality of scan driving units sequentially to provide scan signals respectively to a plurality of scan lines.

In the step S11, the plurality of scan driving units B₁˜B_{N} sequentially provide scan signals respectively to the plurality of scan lines G₁˜G_{N} as per an order from the first scan line G₁ to the Nth scan line G_{N}, so that the scan driving unit B₁ provides a corresponding one of the scan signals to the scan line G₁, the next stage scan driving unit B₂ then provides a corresponding one of the scan signals to the scan line G₂, the further next stage scan driving unit B₃ subsequently provides a corresponding one of the scan signals to the scan line G₃, and so forth, until the scan driving unit B_{N} provides a corresponding one of the scan signals to the scan line G_{N}. Furthermore, when a certain stage scan driving unit B_{K} (k is greater than or equal to 1 and less than or equal to N) is abnormal, the certain stage and all the succeeding stage(s) scan driving units B_{K}˜B_{N} will no longer provide corresponding scan signals respectively to the scan lines G_{K}˜G_{N}.

Step S12: detecting a pulse signal sequence(s) induced on at least one data line crossing over and capacitively coupling with the plurality of scan lines.

In the step S12, a plurality of data lines 12 are arranged crossing over and capacitively coupling with the plurality of scan lines G₁˜G_{N}. As illustrated in FIG. 1, each of the data lines 12 is perpendicularly crossing over all the scan lines G₁˜G_{N}, and the data line 12 and each of the scan lines form a coupling capacitor C _{gd} therebetween, so that the scan signals on the plurality of scan lines G₁˜G_{N} would induce a pulse signal sequence on each of the data lines 12 by corresponding coupling capacitors C_{gd}. The liquid crystal panel further is disposed with a detecting terminal(s) 13 electrically connected to at least one data line 12, and each detecting terminal 13 is configured for outputting a pulse signal sequence induced on the data line 12 by the scan signals.

Step S13: determining a position of an abnormal scan driving unit in a scan driving circuit according to the pulse signal sequence(s).

In the steps S11˜S13, for example, the liquid crystal panel may include a plurality of detecting terminals 13 respectively electrically connected to ends of the plurality of data lines 12, and each of the plurality of detecting terminals 13 is configured for outputting a pulse signal sequence induced on a corresponding data line 12 by the scan signals. In this situation, the step of detecting a pulse signal sequence(s) induced on at least one data line crossing over and capacitively coupling with the plurality of scan lines includes: obtaining a plurality of pulse signal sequences outputted by the plurality of detecting terminals electrically connected to the plurality of data lines crossing over the scan lines, and the step of determining a position of an abnormal scan driving unit in a scan driving circuit according to the pulse signal sequence(s) includes: summarizing the plurality of pulse signal sequences to determine the position of the abnormal scan driving unit in the scan driving circuit. For example, the step of summarizing the plurality of pulse signal sequences to determine the position of the abnormal scan driving unit in the scan driving circuit may be that: comparing the plurality of pulse signal sequences, taking out a pulse signal sequence(s) different from most other pulse signal sequences to thereby obtain normal/correct pulse signal sequences, and then determining the position of the abnormal scan driving unit in the scan driving circuit according to the normal pulse signal sequences; or, the step of summarizing the plurality of pulse signal sequences to determine the position of the abnormal scan driving unit in the scan driving circuit may be that: determining a quantity of pulse signal of each of the plurality of pulse signal sequences, and determining the position of the abnormal scan driving unit in the scan driving circuit according to the maximum quantity of pulse signal. Referring to FIG. 2a, FIG. 2a is a schematic structural view of a liquid crystal panel disposed with only one detecting terminal according to another embodiment of the invention. For example, the liquid crystal panel may be disposed with only one detecting terminal 13 electrically connected to an end of one data line 12, and the detecting terminal 13 is configured for outputting a pulse signal sequence induced on the data line 12 by the scan signals. In this situation, the step of detecting a pulse signal sequence(s) induced on at least one data line crossing over and capacitively coupling with the plurality of scan lines includes: obtaining a pulse signal sequence by the detecting terminal electrically connected to one data line crossing over the scan lines.

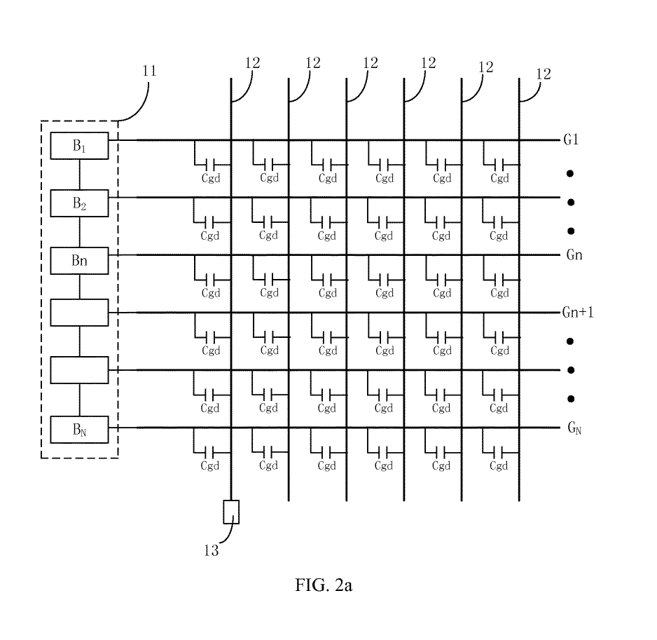

In the steps S11˜S13, the step of controlling a plurality of scan driving units sequentially to provide scan signals respectively to a plurality of scan lines includes: controlling N numbers of scan driving units sequentially to provide scan signals respectively to N numbers of scan lines as per an order from the first scan line to the Nth scan line, where N≧3; a step of determining the position of the abnormal scan driving unit in the scan driving circuit according to a quantity of pulse signal includes: comparing the quantity of pulse signal n with the quantity of scan line N (also referred to as quantity N of the scan lines), and if the quantity of pulse signal n is less than the quantity of scan line N, determining the scan driving unit corresponding to the (n+1)th scan line as abnormal. In conjunction with FIG. 3, FIG. 3 is a timing diagram of a pulse signal sequence, a clock signal sequence and scan signals on respective scan lines. In particular, a pulse signal sequence induced on the data line 12 by the scan signal A₁ on the first scan line G₁ is P₁, a pulse signal sequence induced on the data line 12 by the scan signal A₂ on the second scan line G₂ is P₂, a pulse signal sequence induced on the data line 12 by the scan signal Aₙ on the nth scan line Gₙ is Pₙ, and thereby form a pulse signal sequence P. The quantity of the pulse signals P₁˜Pₙ, (also referred to as quantity of pulse signal) in the pulse signal sequence P is n, the quantity of pulse signal n then is compared with the quantity of scan line N, if the quantity of pulse signal n is less than the quantity of scan line N, it is determined that an abnormal scan driving unit is existed, and the scan driving unit Bₙ₊₁ corresponding to the (n+1)th scan line is determined as abnormal.

Another situation is that: as illustrated in FIG. 3, the position of an abnormal scan driving unit in a scan driving circuit can be determined by comparing the pulse signal sequence P with the clock signal sequence C. Specifically, the step of controlling a plurality of scan driving units sequentially to provide scan signals respectively to a plurality of scan lines includes: using N numbers of clock signals sequentially to control N numbers of scan driving units to provide scan signals to N numbers of scan lines as per an order from the first scan line to the Nth scan line, where N≧3; a step of determining a position of an abnormal scan driving unit in a scan driving circuit according to a quantity of pulse signal includes: comparing the quantity of pulse signal with a quantity N of the clock signals (also referred to as quantity of clock signal N) in the clock signal sequence C, and if the quantity of pulse signal n is less than the quantity of clock signal N, determining the scan driving unit corresponding to the (n+1)th scan line as abnormal.

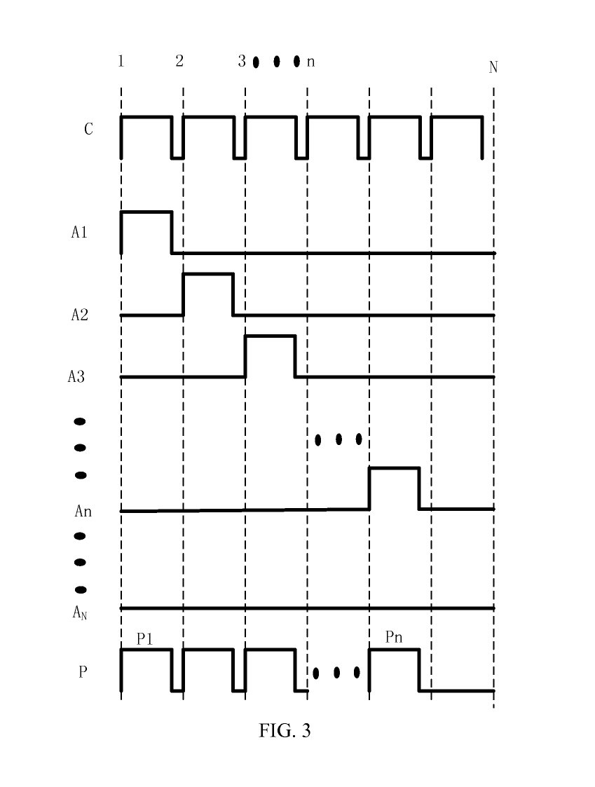

Still another situation is that: in an actual detecting process, resulting from leakage of electricity of the display panel itself, the pulse signal sequence P is not an ideal square waveform but is an attenuated waveform, and the detail is illustrated in FIG. 4. FIG. 4 is a schematic view of another waveform of a pulse signal sequence according to an embodiment of the invention.

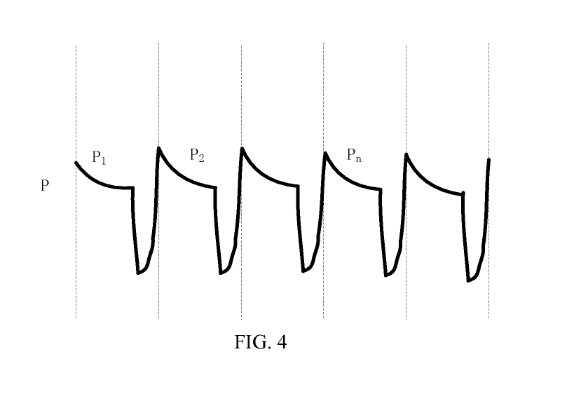

Referring to FIG. 5, FIG. 5 is a schematic structural view of another liquid crystal panel according to an embodiment of the invention, in the illustrated embodiment, the liquid crystal panel may include a plurality of detecting terminals 13 electrically connected to ends of a plurality of data lines 12, each of the plurality of detecting terminals 13 is configured for outputting a pulse signal sequence induced on a corresponding data line 12 by scan signals, the data line 12 and the detecting terminal 13 have a controllable switch 14 connected therebetween, the controllable switch 14 is turned on when an enabling terminal EN thereof is at a high level and is turned off when the enabling terminal EN is at a low level, so that it is controllable to use which one(s) of the detecting terminals 13 connected to the plurality of data lines 12 and correspondingly obtain the pulse signal sequence(s) on which one(s) of the plurality of data lines 12.

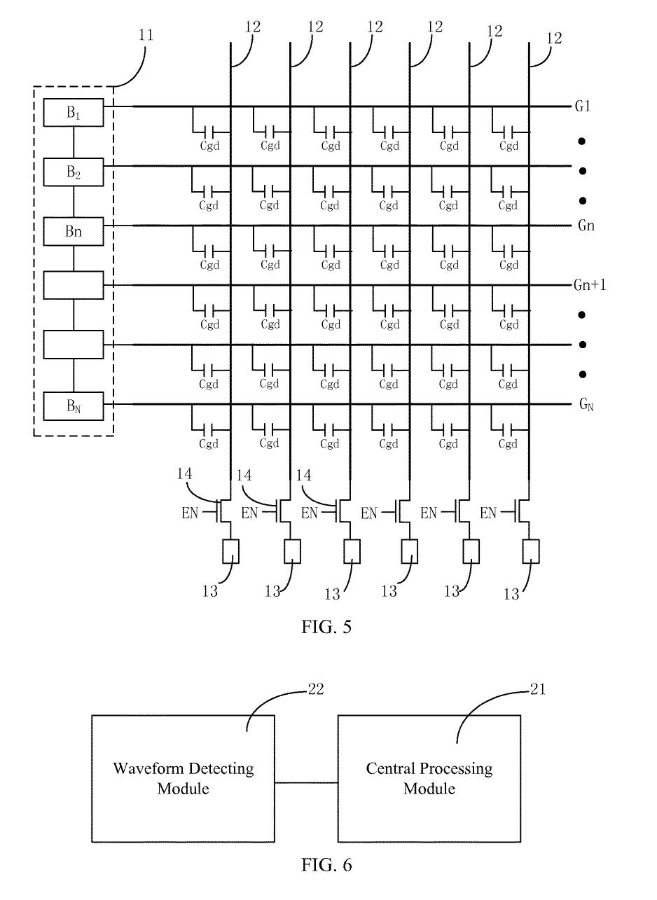

Referring to FIG. 6, FIG. 6 is a schematic block diagram of a detecting apparatus for a scan driving circuit according to an embodiment of the invention. In the illustrated embodiment, the scan driving circuit 11 includes a plurality of scan driving units B₁˜B_{N} connected in cascade, and the detail thereof refers to the foregoing description. The plurality of scan driving units B₁˜B_{N} sequentially provide scan signals respectively to a plurality of scan lines G₁˜G_{N} as per an order from the first scan line G₁ to the Nth scan line G_{N}, so that the scan driving unit B₁ provides a corresponding one of the scan signals to the scan line G₁, the next stage scan driving unit B₂ then provides a corresponding one of the scan signals to the scan line G₂, the further next stage scan driving unit B₃ subsequently provides a corresponding one of the scan signals to the scan line G₃, and so forth, until the scan driving unit B_{N} provides a corresponding one of the scan signals to the scan line G_{N}. Moreover, when a certain stage scan driving unit B_{K} (k is greater than or equal to 1 and less than or equal to N) is abnormal, the certain stage and all the succeeding stage(s) scan driving units B_{K}˜B_{N} will no longer provide corresponding scan signals respectively to the scan lines G_{K}˜G_{N} . The detecting apparatus includes a central processing module 21 and a waveform detecting module 22. The central processing module 21 is configured for controlling the plurality of scan driving units B₁˜B_{N} sequentially to provide scan signals respectively to the plurality of scan lines G₁˜G_{N}. The waveform detecting module 22 is configured for detecting a pulse signal sequence(s) induced on at least one data line crossing over and capacitively coupling with the plurality of scan lines. The central processing module 21 further is configured for determining a position of an abnormal scan driving unit in a scan driving circuit according to the detected pulse signal sequence(s). The plurality of data lines 12 are arranged crossing over and capacitively coupling with the plurality of scan lines G₁˜G_{N}. As illustrated in FIG. 1, each of the data lines 12 is arranged perpendicularly crossing over all the scan lines G₁˜G_{N}, and the data line 12 and each of the scan lines G₁˜G_{N} form a coupling capacitor C_{gd} therebetween, so that the scan signals on the plurality of scan lines G₁˜G_{N} would induce a pulse signal sequence on each of the data lines 12 by corresponding coupling capacitors C_{gd}. The liquid crystal panel further is disposed with a detecting terminal(s) 13 electrically connected to at least one data line 12, and each the detecting terminal 13 is configured for outputting a pulse signal sequence induced on the data line 12 by the scan signals.

Alternatively, the liquid crystal panel may include a plurality of detecting terminals 13 electrically connected to ends of the plurality of data lines 12 respectively, each of the plurality of detecting terminals 13 is configured for outputting a pulse signal sequence induced on a corresponding data line 12 by the scan signals; in this case, the waveform detecting module 22 detects the pulse signal sequence(s) induced on at least one data line 12 crossing over and capacitively coupling with the plurality of scan lines may be that: the waveform detecting module 22 obtain a plurality of pulse signal sequences by the plurality of detecting terminals 13 electrically connected to the plurality of data lines 12 crossing over the scan lines G₁˜G_{N}, and the waveform detecting module 22 is electrically connected to the detecting terminals 13. The central processing module 21 determines the position of the abnormal scan driving unit in the scan driving circuit according to the pulse signal sequence(s) may be that: the central processing module 21 summarizes the plurality of pulse signal sequences to determine the position of the abnormal scan driving unit in the scan driving circuit. Specifically, for example, the central processing module 21 summarizes the plurality of pulse signal sequences to determine the position of the abnormal scan driving unit in the scan driving circuit may be that: the central processing module 21 compares the plurality of pulse signal sequences, takes out a pulse signal sequence(s) different from most other pulse signal sequences to thereby obtain normal/correct pulse signal sequences, and determines the position of the abnormal scan driving unit in the scan driving circuit according to the correct pulse signal sequences. Or, the central processing module 21 summarizes the plurality of pulse signal sequences to determine the position of the abnormal scan driving unit in the scan driving circuit may be that: the central processing module 21 determines a quantity of pulse signal of each of the plurality of pulse signal sequences, and then the central processing module 21 determines the position of the abnormal scan driving unit in the scan driving circuit according to the maximum quantity of pulse signal.

For example, the liquid crystal panel may be disposed with only one detecting terminal 13 electrically connected to an end of one data line 12, and the detecting terminal 13 is configured for a pulse signal sequence induced on the data line 12 by the scan signals. In this case, the waveform detecting module 22 detects the pulse signal sequence(s) induced on at least one data line crossing over and capacitively coupling with the plurality of scan lines may be that: the waveform detecting module 22 obtains the pulse signal sequence outputted by the detecting terminal electrically connected to one data line crossing over the scan lines.

Preferably, the central processing module 21 is configured for determining a quantity of pulse signal of each pulse signal sequence and determining a position of an abnormal scan driving unit in a scan driving circuit according to the quantity of pulse signal.

Preferably, the central processing module 21 is configured for controlling N numbers of scan driving units sequentially to provide scan signals respectively to N numbers of scan lines as per an order from the first scan line to the Nth scan line, where N≧3; and the central processing module 21 further is configured for comparing the quantity of pulse signal n with the quantity of scan line N, and if the quantity of pulse signal n is less than the quantity of scan line N, determining the scan driving unit corresponding to the (n+1)th scan line as abnormal. In addition, the central processing module 21 controls the plurality of scan driving units sequentially to provide scan signals respectively to a plurality of scan lines may be that: the central processing module 21 controls N numbers of scan driving units sequentially to provide scan signals respectively to N numbers of scan lines as per an order from the first scan line to the Nth scan line, where N≧3. The central processing module 21 determines the position of the abnormal scan driving unit in the scan driving circuit according the quantity of pulse signal may be that: the central processing module 21 compares each the quantity of pulse signal n with the quantity of scan line N, and if the quantity of pulse signal n is less than the quantity of scan line N, determines the scan driving unit corresponding to the (n+1)th scan line as abnormal. Referring to FIG. 3, a pulse signal sequence induced on the data line 12 by the scan signal A₁ on the first scan line G₁ is P₁, a pulse signal sequence induced on the data line 12 by the scan signal A₂ on the second scan line G₂ is P₂ , a pulse signal sequence induced on the data line 12 by the scan signal Aₙ on the nth scan line Gₙ is Pₙ, and thereby form a pulse signal sequence P. The quantity of the pulse signals P₁˜Pₙ of the pulse signal sequence P is n, the quantity n of the pulse signals then is compared with the quantity N of the scan lines, if the quantity n of the pulse signals is less than the quantity N of the scan lines, it is determined that an abnormal scan driving unit is existed, and the scan driving unit Bₙ₊₁ corresponding to the (n+1)th scan line is determined as abnormal.

Another case is that: as illustrated in FIG. 3, the central processing module 21 may determine the position of the abnormal scan driving unit in the scan driving circuit according to a comparison of the pulse signal sequence P with the clock signal sequence C. Specifically, the central processing module 21 controls a plurality of scan driving units sequentially to provide scan signals respectively to a plurality of scan lines may be that: the central processing module 21 uses N numbers of clock signals sequentially to control N numbers of the scan driving units to provide scan signals to N numbers of the scan lines as per an order from the first scan line to the Nth scan line, where N≧3. The central processing module 21 determines the position of the abnormal scan driving unit in the scan driving circuit according to the quantity of pulse signal may be that: the central processing module 21 compares the quantity of pulse signal n with the quantity of clock signal N of the clock signal sequence, and if the quantity of pulse signal n is less than the quantity of clock signal N, determines the scan driving unit corresponding to the (n+1)th scan line as abnormal.

Still another case is that: in an actual detecting process, resulting from leakage of electricity of display panel (liquid crystal panel) itself, the pulse signal sequence P is not an ideal square waveform but is an attenuated waveform, and the detail is illustrated in FIG. 4.

Referring to FIG. 5, in the illustrated embodiment, the liquid crystal panel may include a plurality of detecting terminals 13 electrically connected to ends of a plurality of data lines 12, and each of the plurality of detecting terminals 3 is configured for outputting a pulse signal sequence induced on a corresponding one data line 12 by scan signals, the data line 12 and the detecting terminal 13 have a controllable switch 14 connected therebetween, the controllable switch 14 is turned on when an enabling terminal EN thereof is at a high level and is turned off when the enabling terminal EN is at a low level, so that it is controllable to use which one(s) of the plurality of detecting terminals 13 of the plurality of data lines 12 and correspondingly obtain the pulse signal sequence(s) on which one(s) of the plurality of data lines 12.

In summary, the invention detects a pulse signal sequence(s) induced on at least one data line crossing over and capacitively coupling with a plurality of scan lines and determines a position of an abnormal scan driving unit in a scan driving circuit according to the pulse signal sequence(s), and therefore can effectively detect the position of the abnormal scan driving unit in the scan driving circuit.

The foregoing discussion only is some embodiments of the invention, but it is not therefore limited to the patent scope of the invention, any equivalent structure or equivalent process transformations made according to the specification and the accompanying drawings of the invention, or directly or indirectly used in other related technical field, are similarly included within the scope of patent protection of the invention.

What is claimed is:

1. A detecting method for a scan driving circuit, wherein the scan driving circuit comprises a plurality of scan driving units connected in cascade; the detecting method comprising:
controlling the plurality of scan driving units sequentially to provide scan signals respectively to a plurality of scan lines;
detecting a pulse signal sequence(s) induced on at least one data line crossing over and capacitively coupling with the plurality of scan lines; and
determining a position of an abnormal scan driving unit in the scan driving circuit according to the pulse signal sequence(s).

2. The detecting method as claimed in claim 1, wherein the step of determining a position of an abnormal scan driving unit in the scan driving circuit according to the pulse signal sequence(s) comprises:
determining a quantity of pulse signal of each the pulse signal sequence; and
determining the position of the abnormal scan driving unit in the scan driving circuit according to the quantity of pulse signal.

3. The detecting method as claimed in claim 2, wherein
the step of controlling the plurality of scan driving units sequentially to provide scan signals respectively to a plurality of scan lines comprises:
controlling N numbers of scan driving units sequentially to provide scan signals respectively to N numbers of scan lines as per an order from a first scan line to an Nth scan line, where N≧3;
the step of determining the position of the abnormal scan driving unit in the scan driving circuit according to the quantity of pulse signal comprises:
comparing the quantity of pulse signal n with the quantity of scan line N, and if the quantity of pulse signal n is less than the quantity of scan line N, determining the scan driving unit corresponding to an (n+1)th scan line as abnormal.

4. The detecting method as claimed in claim 2, wherein
the step of controlling the plurality of scan driving units sequentially to provide scan signals respectively to a plurality of scan lines comprises:
using N numbers of clock signals sequentially to control N numbers of scan driving units to provide scan signals respectively to N numbers of scan lines as per an order from a first scan line to an Nth scan line, where N≧3;
the step of determining the position of the abnormal scan driving unit in the scan driving circuit according to the quantity of pulse signal comprises:
comparing the quantity of pulse signal n with the quantity of clock signal N, and if the quantity of pulse signal n is less than the quantity of clock signal N, determining the scan driving unit corresponding to an (n+1)th scan line as abnormal.

5. The detecting method as claimed in claim 1, wherein the step of detecting a pulse signal sequence(s) induced on at least one data line crossing over and capacitively coupling with the plurality of scan lines comprises:
obtaining the pulse signal sequence outputted by a detecting terminal electrically connected to one data line crossing over the plurality of scan lines.

6. The detecting method as claimed in claim 1, wherein
the step of detecting a pulse signal sequence(s) induced on at least one data line crossing over and capacitively coupling with the plurality of scan lines comprises:
obtaining a plurality of the pulse signal sequences outputted by a plurality of detecting terminals electrically connected to a plurality of data lines crossing over the plurality of scan lines;
the step of determining a position of an abnormal scan driving unit in the scan driving circuit according to the pulse signal sequence(s) comprises:
summarizing the plurality of pulse signal sequences to determine the position of the abnormal scan driving unit in the scan driving circuit.

7. A liquid crystal panel, wherein the liquid crystal panel comprises a scan driving circuit, a plurality of data lines and a plurality of scan lines; the scan driving circuit comprises a plurality of scan driving units connected in cascade, the plurality of scan driving units are configured for sequentially providing scan signals respectively to the plurality of scan lines, the plurality of data lines are crossing over and capacitively coupling with the plurality of scan lines; the liquid crystal panel further is disposed with a detecting terminal(s) electrically connected to at least one of the plurality of data lines, the detecting terminal(s) is/are configured for outputting a pulse signal sequence(s) induced on the at least one data line by the scan signals.

8. A detecting apparatus for a scan driving circuit, wherein the scan driving circuit comprises a plurality of scan driving units connected in cascade, the detecting apparatus comprises a central processing module and a waveform detecting module, the central processing module is configured for controlling the plurality of scan driving units sequentially to provide scan signals respectively to a plurality of scan lines, the waveform detecting module is configured for detecting a pulse signal sequence(s) induced on at least one data line crossing over and capacitively coupling with the plurality of scan lines, and the central processing module further is configured for determining a position of an abnormal scan driving unit in the scan driving circuit according to the pulse signal sequence(s).

9. The detecting apparatus as claimed in claim 8, wherein the central processing module is configured for determining a quantity of pulse signal of each the pulse signal sequence and determining the position of the abnormal scan driving unit in the scan driving circuit according to the quantity of pulse signal.

10. The detecting apparatus as claimed in claim 9, wherein the waveform detecting module is configured for obtaining the pulse signal sequence outputted by a detecting terminal electrically connected to one data line crossing over the plurality of scan lines; or the waveform detecting module is configured for obtaining a plurality of the pulse signal sequences outputted by a plurality of detecting terminals electrically connected to the plurality of data lines crossing over the plurality of scan lines, and the central processing module further is configured for summarizing the plurality of pulse signal sequences to determine the position of the abnormal scan driving unit in the scan driving circuit.

11. The detecting apparatus as claimed in claim 9, wherein the central processing module is configured for controlling N numbers of scan driving units sequentially to provide scan signals respectively to N numbers of scan lines as per an order from a first scan line to an Nth scan line, where N≧3; the central processing module further is configured for comparing the quantity of pulse signal n with the quantity of scan line N, and if the quantity of pulse signal n is less than the quantity of scan line N, determining the scan driving unit corresponding to an (n+1) scan line as abnormal.

12. The detecting apparatus as claimed in claim 9, wherein the central processing module is configured for using N numbers of clock signals sequentially to control N numbers of scan driving units to provide scan signal respectively to N numbers of scan lines as per an order from a first scan line to an Nth scan line, where N≧3; the central processing module further is configured for comparing the quantity of pulse signal n with the quantity of clock signal N, and if the quantity of pulse signal n is less than the quantity of clock signal N, determining the scan driving unit corresponding to an (n+1) scan line as abnormal.
